(19) United States
(12) Patent Application Publication
(10) Pub. No.: US 2026/0030285 A1
(43) Pub. Date: Jan. 29, 2026

(54) DOCUMENT CLASSIFICATION USING FREE-FORM INTEGRATION OF MACHINE LEARNING MODELS

(71) Applicant: RecordPoint Software Holdings Pty Ltd., Sydney (AU)

(72) Inventors: Jason Morris Franks, Burwood (AU); Anthony David Woodward, Sydney (AU)

(21) Appl. No.: 18/786,210

(22) Filed: Jul. 26, 2024

(51) Int. Cl. G06F 16/35; G06F 16/31; G06F 16/383

(52) U.S. Cl. CPC G06F 16/355; G06F 16/322; G06F 16/383

(57) ABSTRACT

The technology automatically classifies documents using a decision tree integrating both rule-based nodes and machine learning (ML) model-based nodes. Rule-based nodes evaluate document information against predefined rules to generate classifications, while ML model-based nodes provide classifications along with the corresponding confidence level probabilities. Upon receiving an unclassified set of documents, the technology classifies each document by traversing the decision tree. At rule-based nodes, document evaluation entails comparing outcomes of logical conditions within the node. At ML model-based nodes, the evaluation depends on confidence level probabilities meeting predefined thresholds for each node. Using the evaluations, the technology assigns a proposed classification to each document. Once all documents have been classified, the technology generates a set of classified documents.

### BACKGROUND

Document classification involves the categorization of documents into predefined classes or categories based on the document's content, structure, or metadata attributes. Document classification aims to systematically arrange documents to facilitate efficient information retrieval, management, and analysis. Each document is assigned to one or more predefined categories or labels which allows users to more easily locate relevant documents. Rule-based document classification uses predefined logical rules to categorize documents into specific classes or categories. The rules typically consist of if-then statements that specify conditions to be met for assigning a document to a particular category. However, rule-based nodes struggle to adapt to the evolving nature across sets of documents and lack the flexibility to handle unstructured or poorly structured documents effectively.

Artificial intelligence (“AI”) models often operate based on extensive and enormous training models. The models include a multiplicity of inputs and how each should be handled. Then, when the model receives a new input, the model produces an output based on patterns determined from the data the model was trained on.

### BRIEF DESCRIPTION OF THE DRAWINGS

The disclosure may be more completely understood in consideration of the following detailed description of various implementations of the disclosure in connection with the accompanying drawings, in which:

FIG. 1 is a system diagram illustrating an example of a computing environment in which the disclosed system operates in some implementations of the present technology.

FIG. 2 is a block diagram that illustrates a rule-based document classification system using rule-based nodes.

FIG. 3 is a block diagram that illustrates a document classification system using free-form integration of machine learning (ML) model-based nodes that can implement aspects of the present technology.

FIG. 4 is a block diagram that illustrates a document classification system using free-form integration of machine learning (ML) model-based nodes that can implement aspects of the present technology.

FIG. 5 is a flowchart that illustrates a process performed by a document classification system using free-form integration of ML models.

FIG. 6 is a block diagram that illustrates structured metadata and unstructured content within a document that can implement aspects of the present technology.

FIG. 7 is a block diagram illustrating a document classification system redirecting the control flow of traversing the decision tree that can implement aspects of the present technology.

FIG. 8 is a high-level block diagram illustrating an example AI system, in accordance with one or more implementations.

FIG. 9 is a block diagram illustrating an example computer system, in accordance with one or more implementations.

### DETAILED DESCRIPTION

Document classification plays a crucial role in various domains, including data organization, search engines, recommendation systems, and information retrieval, which facilitates access to relevant information and aids decision-making processes. Traditional document classification approaches rely heavily on rule-based systems, where a set of rules is manually defined based on the characteristics of the documents and the documents' metadata attributes. The rules serve as logical guidelines for categorizing documents into predefined classes or categories. By analyzing document metadata such as author information, creation date, keywords, and other contextual data, rule-based systems determine the appropriate classification for each document.

However, the inherent rigidity of rule-based systems built upon predefined logical rules may not adequately capture the complexity and variability of document content. As a result, rule-based nodes struggle to adapt to the evolving nature across sets of documents and lack the flexibility to handle unstructured or poorly structured documents effectively. For example, certain types of documents containing unstructured data (e.g., social media posts) in the form of text, audio, video, and/or image data, which typically constitutes the majority of all digital data, do not fit perfectly into any rules in the rule-based systems and would be considered “unclassified,” requiring more labor-intensive review on the back end.

Additionally, the scalability and maintainability of rule-based systems is limited. Constructing and managing a comprehensive set of rules to cover all possible document types and categories can be a labor-intensive and error-prone process. As the volume and diversity of digital content continue to grow, maintaining and updating rule-based systems becomes increasingly challenging, leading to potential gaps in classification coverage and accuracy. Rule-based systems typically require manual intervention to update rules or incorporate new knowledge, which can be time-consuming and resource-intensive. For example, if a new financial regulatory requirement mandates considering additional factors in the loan approval process, the rule-based system needs to be reprogrammed accordingly. Reprogramming the rule-based system involves identifying the specific rules affected by the change, modifying the rules' logic, and testing the updated system to ensure the system's accuracy. As the volume of documents (e.g., loan applications) increases and the complexity of regulations grows, the manual effort required to maintain and update the rule-based system becomes increasingly burdensome.

Furthermore, rule-based systems lack the capability to capture nuanced patterns and relationships present in document content. Rule-based systems rely on explicit rules defined by human experts, which overlooks subtle variations or correlations within the data. For example, a law firm can have rules that classify documents containing specific legal terminology or citations to relevant case law such as “precedent-setting cases” or “legal opinions.” However, a legal brief discussing a complex legal issue where the key arguments are presented in a narrative format (e.g., unstructured data), rather than following a standard structure may contain relevant legal concepts and citations, but the unconventional structure may cause the document to be overlooked by the rule-based system. In another example, when a set of documents includes unstructured customer reviews, and a user desires to categorize the customer reviews into relevant categories or topics, such as product satisfaction, service quality, delivery experience, and product features, traditional rule-based systems struggle to effectively classify unstructured data due to the complexity and variability of language used by customers, the presence of informal language, spelling variations, and the absence of standardized formats. For reviews that contain both positive and negative sentiments (e.g., “The product arrived late, but the quality was excellent”) traditional rule-based systems struggle to determine the overall sentiment and categorize the sentiment accurately.

As a result, rule-based nodes struggle to achieve the level of accuracy and granularity required for effective document classification, particularly when dealing with complex or ambiguous content.

The present disclosure relates to automated document classification and is directed to the above discussed shortcomings and others of traditional systems of document classification/categorization. The disclosed system maintains a decision tree consisting of a set of decision nodes, including both rule-based nodes and machine learning (ML) model-based nodes. Each rule-based node generates a node classification by evaluating document information against predefined rules, while each ML model-based node can produce a classification and a probability indicating the confidence level in the classification. The method receives an unclassified set of documents, which are subsequently classified by traversing through the decision tree. At rule-based nodes, document evaluation entails the comparison of outcomes of logical conditions within the node. Meanwhile, at ML model-based nodes, evaluation is based on confidence level probabilities satisfying predefined thresholds. The method can iteratively refine the node classification of each document using a plurality of ML model-based nodes. As the system traverses through the decision tree, the classifications of subsequent ML model-based nodes can become progressively narrower than those of previous nodes to gradually classify the document into narrower classifications.

In one aspect, the method dynamically determines a specific ML model from multiple models for a corresponding decision node within the decision tree based on confidence levels. Additionally, evaluation thresholds of ML model-based nodes are dynamically adjusted based on structured metadata or unstructured content associated with each document, thereby improving classification accuracy.

For example, in the customer review above that states, “The product arrived late, but the quality was excellent,” the system can initially evaluate the review's structured metadata to ascertain the review's relevance, such as identifying the review as product delivery-related feedback. Subsequently, the system can use machine learning at other decision nodes and evaluate the unstructured content of the review. The ML model can discern the mixed sentiment within the review, acknowledging both positive and negative aspects. Upon classification, the ML model not only assigns a category to the review but also provides a probability reflecting the category's confidence level. The probabilistic insight can guide subsequent decision-making processes within the traversal of the decision tree. If the confidence level meets predefined thresholds, the system can proceed to propose a classification for the review. However, if further refinement is necessary, the system can iteratively traverse additional nodes for further evaluation.

By moving away from the inherent rigidity of predefined logical rules, the system can adapt to the complexity and variability of document content. ML model-based nodes within the classification system are capable of learning from patterns and relationships present in the data, offering a more flexible and dynamic approach to classification. For example, for documents containing unstructured data, such as social media posts, the system can learn from the patterns and trends present in the posts, and classify the posts accurately despite the variability.

Moreover, the scalability and maintainability of the classification system are improved, since, unlike rule-based systems that rely on constructing and managing a comprehensive set of predefined rules, ML-based approaches requires less manual intervention and are more adaptable to changes in document types and categories. As the volume and diversity of digital content continues to grow, the system can adapt to new product categories and attributes automatically as the system learns from the updated data, reducing the need for manual rule maintenance. Additionally, it is more economical and faster to tune the classification system with an ML-based approach because the ML-based classification system requires fewer computational resources and less time to update. For example, the ML-based classification system can be adjusted and fine-tuned without the need to modify the surrounding infrastructure or downstream models due to the modular architecture of the ML-based classification system.

Additionally, the ML model-based nodes can capture nuanced patterns and relationships present in document content. Unlike rule-based systems, which can overlook subtle variations or correlations, ML-based nodes can identify complex structures and interpret content more holistically. For example, in the legal domain, ML algorithms can analyze the semantic relationships within the text and accurately classify documents based on the underlying concepts.

Various features of the hierarchical model integration system introduced above will now be described in further detail. The following description provides specific details for a thorough understanding and enabling description of these examples. One skilled in the relevant art will understand, however, that the technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Hierarchical Model Integration System

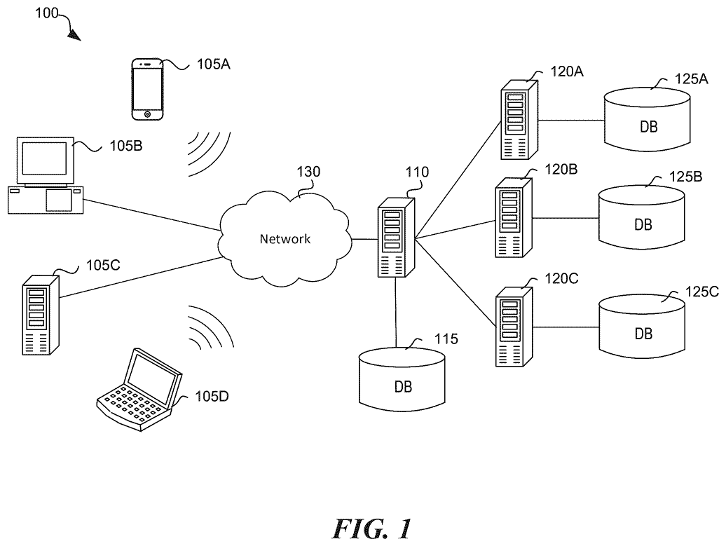

FIG. 1 is a system diagram illustrating an example of a computing environment in which the disclosed system operates in some implementations. In some implementations, system 100 includes one or more client computing devices 105A-D, examples of which can host the system 100. Client computing devices 105 operate in a networked environment using logical connections through network 130 to one or more remote computers, such as a server computing device.

In some implementations, server 110 is an edge server that receives client requests and coordinates fulfillment of those requests through other servers, such as servers 120A-C. In some implementations, server computing devices 110 and 120 comprise computing systems, such as the system 100. Though each server computing device 110 and 120 is displayed logically as a single server, server computing devices can each be a distributed computing environment encompassing multiple computing devices located at the same or at geographically disparate physical locations. In some implementations, each server 120 corresponds to a group of servers.

Client computing devices 105 and server computing devices 110 and 120 can each act as a server or client to other server or client devices. In some implementations, servers (110, 120A-C) connect to a corresponding database (115, 125A-C). As discussed above, each server 120 can correspond to a group of servers, and each of these servers can share a database or can have its own database. Databases 115 and 125 warehouse (e.g., store) information such as home information, recent sales, home attributes, and so on. Though databases 115 and 125 are displayed logically as single units, databases 115 and 125 can each be a distributed computing environment encompassing multiple computing devices, can be located within their corresponding server, or can be located at the same or at geographically disparate physical locations.

Network 130 can be a local area network (LAN) or a wide area network (WAN), but can also be other wired or wireless networks. In some implementations, network 130 is the Internet or some other public or private network. Client computing devices 105 are connected to network 130 through a network interface, such as by wired or wireless communication. While the connections between server 110 and servers 120 are shown as separate connections, these connections can be any kind of local, wide area, wired, or wireless network, including network 130 or a separate public or private network.

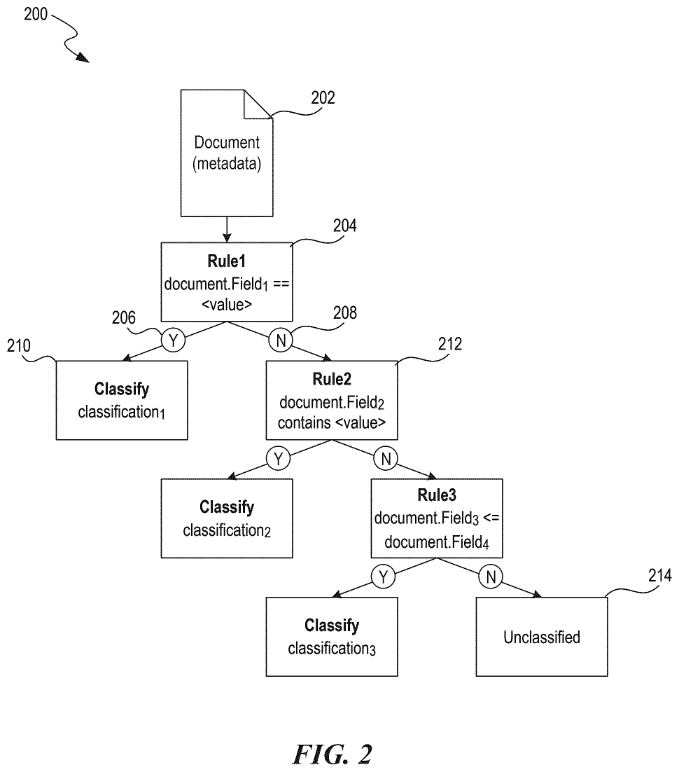

FIG. 2 is a block diagram that illustrates a rule-based document classification system 200 using rule-based nodes. The document classification system 200 includes an unclassified document 202, rule-based nodes 204, 212, edges 206, 208, classifications 210, and unclassified category 214. The unclassified document 202 can be any piece of content (e.g., text, audio, visual) that enters the rule-based document classification system 200 without a predetermined classification. The unclassified document 202 can lack explicit metadata or classification tags that would place them into predefined categories within the classification system. Unclassified documents can be news articles, research papers, emails, or social media posts that contain content but are not explicitly labeled with a category. The unclassified document 202 can vary in length, complexity, and format, ranging from short text snippets to lengthy reports or multimedia presentations. Examples of unclassified documents include news articles, research papers, emails, or social media posts. Further examples of unclassified documents can also include multimedia content such as audio recordings, images, or videos that lack descriptive metadata or annotation.

In FIG. 2, the unclassified document 202 begins traversing through the decision tree at rule-based node 204. The unclassified document 202 systematically progresses through various decision nodes within the decision tree. Each decision node represents a point in the classification process where specific criteria or conditions are evaluated to determine the unclassified document's 202 classification. A rule-based node denotes a decision node within the decision tree that employs predefined rules or logical conditions to assess the unclassified document's 202 metadata attributes. The unclassified document's 202 metadata attributes refer to the structured information associated with the document (e.g., author name, publication date, email). The metadata attributes provide contextual insights of the unclassified document 202 used in classifying the unclassified document 202.

The rules or conditions in each rule-based node 204 can be formulated based on the characteristics of the unclassified document 202 and their metadata attributes. For example, rule-based node 204 is defined by a logical condition (e.g., “document.Field1==<value>”), which serves as a criterion for evaluating the document's metadata (e.g., structured) attributes. For example, the logical condition “document.Field1==<value>” can include evaluating whether the value of a specific metadata field, such as “Field1,” is equal to “value,” to classify the unclassified document's 202.

In some implementations, the rule-based systems use external data sources to classify unclassified document 202. For example, the system can use external data related to a recent news event, a user's activity on social media platforms, or data from third-party vendors to impact the unclassified document's 202 classification. By using both the metadata attributes and external data sources, rule-based systems can create more contextually relevant classification rules. The rule-based systems can obtain the external data, for example, via an Application Programming Interface (API) based on the type of unclassified documents 202. For example, for loan applications, the rule-based systems can use an Application Programming Interface (API) provided by financial institutions or credit bureaus and access a relevant set of attributes typically associated with loan applications, such as income, employment status, and credit history. In some implementations, rather than relying solely on an API, the rule-based systems can utilize web scraping techniques to extract data from online sources such as databases, websites, or other repositories.

If the unclassified document 202 satisfies the criteria and/or conditions set by the rule-based node 204, shown by edge 206, the system assigns the unclassified document 202 a classification 210, which indicates that the unclassified document 202 belongs to a specific category or class, where each specific category or class has a shared feature within the content of the corresponding documents. The classification 210 assigned to the unclassified document 202 can represent various attributes or characteristics inferred from the unclassified document's 202 metadata, such as the unclassified document's 202 topic, genre, or relevance to a particular domain. The classification 210 provides a structured representation of the unclassified document's 202 content, and can allow for easier organization, retrieval, and analysis of documents within a given dataset or repository.

However, if the unclassified document 202 fails to meet the criteria and/or conditions specified by the rule-based node 204, shown by edge 208, the system proceeds to a subsequent rule-based node 212 in the decision tree. The subsequent rule-based node 212 can pose a different query or condition to the unclassified document 202, such as whether “document.Field2 contains <value>,” introducing a new set of criteria and/or metadata attributes against which the unclassified document 202 is evaluated. The process further refines the classification process by incorporating additional factors or characteristics from the unclassified document's 202 metadata, leading to a more narrow or specific classification outcome.

As the traversal through the decision tree continues, the unclassified document 202 progresses through successive rule-based nodes within the decision tree. At each rule-based node 204, 212, the system applies a specific set of rules and/or conditions to evaluate the unclassified document 202 and determine the next step in the classification process. At each rule-based node 204, 212, the system assesses the document against the predefined rules or conditions to determine the subsequent action. The assessment involves comparing the unclassified document's 202 attributes with the criteria specified by the rule-based node's 204, 212 rules, leading to one of several outcomes: progressing to the next rule-based node, assigning a classification based on the rule-based node's 204, 212 criteria, or determining that the document cannot be classified based on the current set of rule-based nodes.

The iterative evaluation process continues until the unclassified document 202 reaches a leaf node in the decision tree. A leaf node represents the endpoint of a classification pathway within the decision tree, where no further nodes are available for traversal. Upon reaching a leaf node, the system assigns the unclassified document 202 a proposed classification 210 based on the collective evaluations performed throughout the unclassified document's 202 traversal. The proposed classification 210 represents the system's best estimate of the unclassified document's 202 category or class based on the accumulated assessments made at each rule-based node 204, 212.

However, if the unclassified document 202 does not satisfy any of the conditions set by the decision nodes within the tree, the unclassified document 202 remains unclassified 214, indicating that the system could not assign the unclassified document 202 to any specific category or class. When the unclassified document's 202 attributes do not align with any of the conditions in rule-based nodes 204, 212, the system cannot make a definitive classification decision, leading to the document being labeled as unclassified. The conventional system of solely relying on rule-based classification results in more documents being left unclassified if the unclassified document's 202 attributes do not align with rigid predefined rules or conditions.

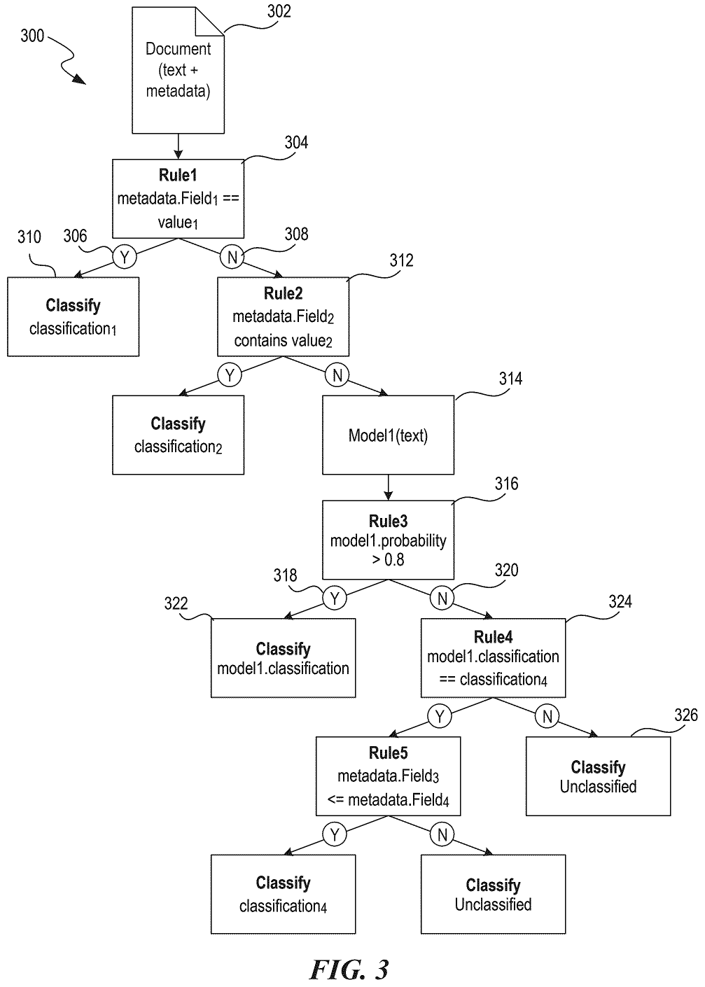

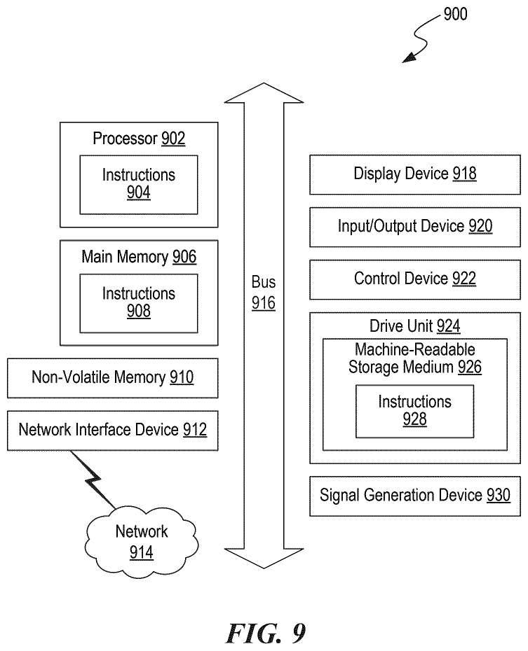

FIG. 3 is a block diagram that illustrates a document classification system 300 using free-form integration of machine learning (ML) model-based nodes that can implement aspects of the present technology. The document classification system 300 includes an unclassified document 302, rule-based nodes 304, 312, 324, ML model-based node 314, edges 306, 308, 318, 320, classifications 310, 322, 326, and an unclassified category 326. An example unclassified document 302 is illustrated and described in more detail with reference to FIG. 2. Example rule-based nodes 304, 312, 324 are illustrated and described in more detail with reference to FIG. 2. The document classification system 300 can be implemented using components of the example computer system 900 illustrated and described in more detail with reference to FIG. 9. Likewise, implementations of the document classification system 300 can include different and/or additional components that can be connected in different ways.

The unclassified document 302 traverses through the decision tree starting from a decision node (e.g., a rule-based node, a model-based node). For example, in FIG. 3, the unclassified document 302 begins from the rule-based node 304. The rule-based node 304 evaluates specific criteria based on the document's structured metadata, such as “document. Field1==<value>” to determine the unclassified document's 302 initial classification. The criteria assessed by the rule-based node 304 are expressed as logical conditions, such as “document.Field1==<value>,” where Field1 represents a particular attribute within the document's metadata, and <value>signifies a specific value or condition to be matched.

If the unclassified document 302 meets the conditions set by the rule-based node 304 (as shown by edge 306), the unclassified document 302 can receive a classification 310 to indicate the unclassified document's 302 categorization within a predefined class.

Where the unclassified document fails to satisfy the rule-based conditions (as shown by edge 308), the system proceeds to subsequent decision nodes, such as rule-based node 312, which pose additional logic-based queries to refine the classification process based on the structured data of the unclassified document 302.

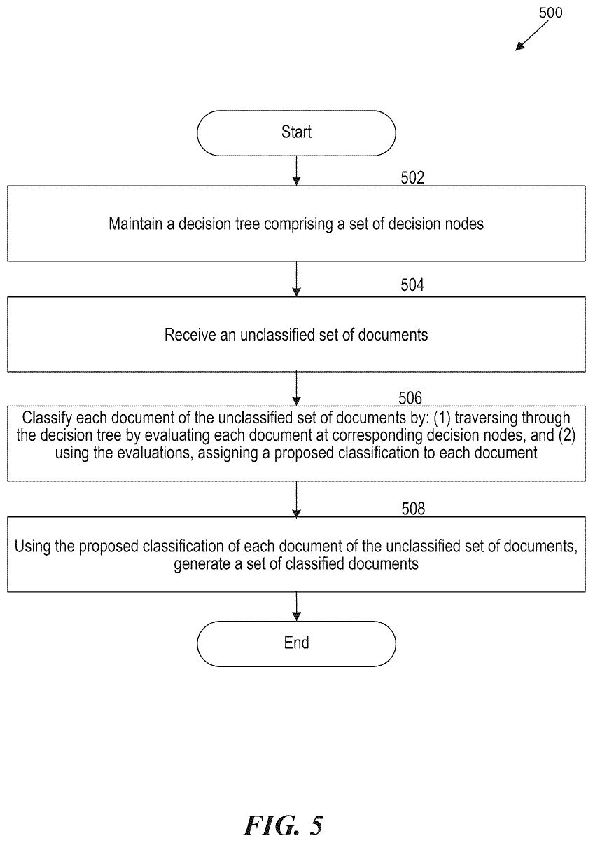

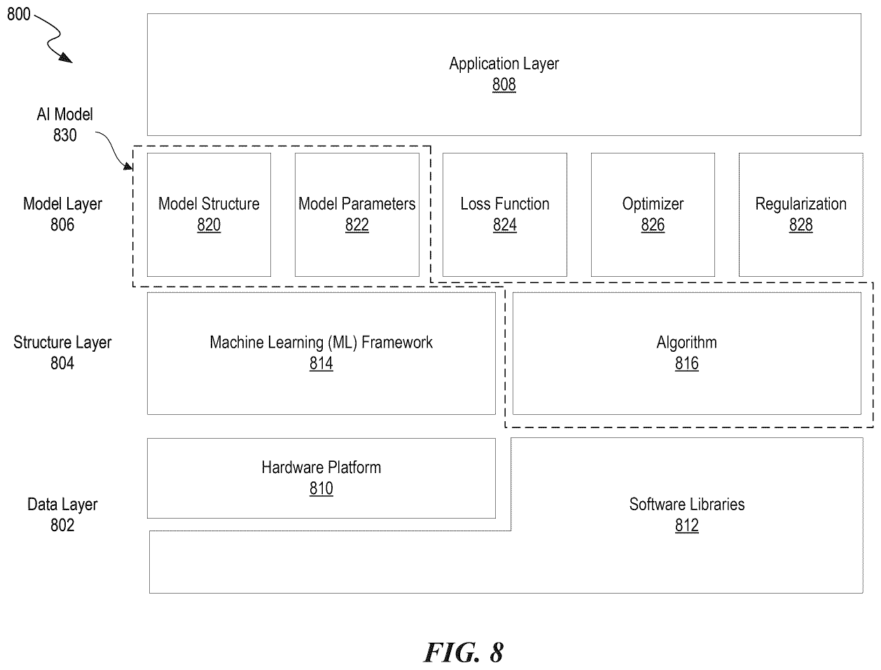

Within the decision tree, the ML model-based node 314 enhances the classification process by analyzing both structured metadata and unstructured data of the unclassified document 302, such as text, within the document. The model-based node 314 refers to a decision node in the decision tree that employs machine learning algorithms to analyze document content. The node can process both structured metadata, such as author, title, and date, and unstructured data, such as text and/or audiovisuals to extract additional insights of the unclassified document 302. The output of the ML model-based node 314 is a probability or confidence level that reflects the likelihood of the unclassified document 302 belonging to a particular category or class. In some implementations, the outputs of the model, including the particular categories/classes and corresponding probability values (p-values), can then be considered new metadata for further classification. For example, the new metadata can be used to perform further evaluations by rule-based nodes. Methods and algorithms used within the ML model of the ML model-based node 314 are illustrated and described in more detail with reference to FIG. 5 and FIG. 8.

The integration of ML model-based nodes offers a significant advantage, as the ML model-based nodes allow the system to not only analyze structured metadata but also interpret unstructured data, contributing to a more comprehensive classification process. The model-based node 314 allows for a more nuanced understanding of the document's content and context and contributes to more accurate classifications. In some implementations, multiple model-based nodes with different machine-learning algorithms can be incorporated into the decision tree. Each model-based node can specialize in analyzing specific types of unstructured data or extracting distinct features from the unclassified document's 302 content. The diversified approach can provide a more comprehensive analysis of the document and improve classification accuracy.

Furthermore, a rule-based node 316 can determine subsequent nodes based on predefined threshold probabilities or confidence levels output by a model-based node (e.g., model-based node 314). The predefined threshold serves as a benchmark against which the output probability from the model-based node is evaluated. For example, if the rule-based node 316 specifies a threshold probability of “0.8,” and the resulting probability from the model-based node 314 satisfies the criterion via edge 318, the system assigns a classification 322 to the unclassified document 302. Conversely, if the resulting probability from the model-based node 314 fails to meet the threshold via edge 320, the system can either assign another decision node (e.g., rule-based node 324) or determine that the document remains unclassified 326.

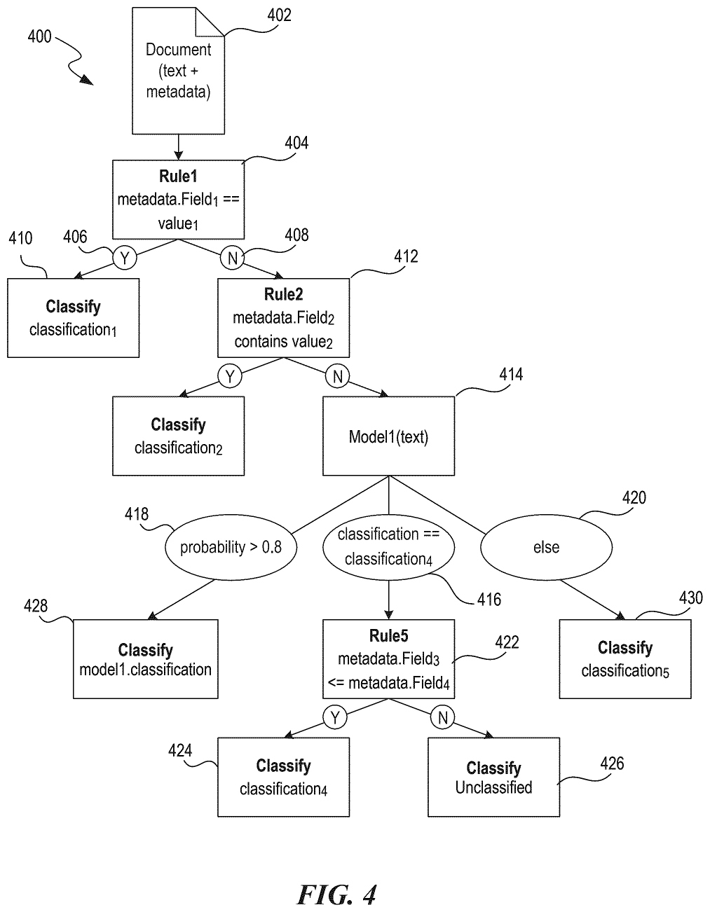

FIG. 4 is a block diagram that illustrates a document classification system 400 using free-form integration of machine learning (ML) model-based nodes that can implement aspects of the present technology. The document classification system 400 includes an unclassified document 402, rule-based nodes 404, 412, 422, ML model-based node 414, edges 406, 408, 416, 418, 420, classifications 410, 424, 430, and an unclassified category 426. An example unclassified document 402 is illustrated and described in more detail with reference to FIG. 2. Example rule-based nodes 404, 412, 422 are illustrated and described in more detail with reference to FIG. 2. The document classification system 400 can be implemented using components of the example computer system 900 illustrated and described in more detail with reference to FIG. 9. Likewise, implementations of the document classification system 400 can include different and/or additional components that can be connected in different ways.

The classification process begins with the unclassified document 402 traversing through the decision tree, initiating from a decision node such as the rule-based node 404. The rule-based node 404 evaluates specific criteria based on the unclassified document's 402 structured metadata, such as “document.Field1==<value>,” to determine the unclassified document's 402 initial classification. If the unclassified document 402 satisfies the conditions set by the rule-based node 404 (as depicted by edge 406), the unclassified document 402 receives a classification 410. Conversely, if the unclassified document 402 fails to meet these conditions (as shown by edge 408), the system proceeds to subsequent decision nodes, such as node 412, which pose additional queries to refine the classification process based on other metadata attributes. The model-based node 414 outputs a probability or confidence level reflecting the document's classification.

The decision tree dynamically determines subsequent actions based on the probability or confidence level provided by the model-based node 414. For example, if the probability exceeds a predefined threshold (edge 418), which can indicate a high level of certainty in the classification, the system assigns a classification 428 to the document. Alternatively, if the unclassified document 402 is assigned a classification by the model-based node 414 but does not surpass the threshold, which can suggest uncertainty in the classification but still provide some level of insight, the unclassified document 402 can be classified based on the classification (edge 416) provided by the model-based node 414 and proceed to subsequent decision nodes, such as the rule-based node 422.

Moreover, the model-based node 414 can assign a classification 430 in response to scenarios where the unclassified document 402 does not fall into other predefined categories, as indicated by the “else” condition (edge 420). The system can assign a distinct classification based on already unique characteristics or attributes of the unclassified document 402 that were determined in previous nodes.

FIG. 5 is a flowchart that illustrates a process 500 performed by a document classification system using free-form integration of ML models. In one example, the process 500 is performed by a document classification system (e.g., the document classification system 300 of FIG. 3, the document classification system 400 of FIG. 4) to generate a classification (e.g., the classifications 310, 322, 326 of FIG. 3, the classifications 410, 424, 430 of FIG. 4). The process 500 can be performed by a client computing device and/or a server computing device (e.g., client computing devices 105 and server computing devices 110 and 120 of FIG. 1). In some implementations, the process 500 is performed by a computer system, e.g., computer system 900 illustrated and described in more detail with reference to FIG. 9. Likewise, implementations can include different and/or additional steps or can perform the steps in different orders.

In step 502, the document classification system maintains a decision tree that contains a set of decision nodes. The set of decision nodes can include one or more rule-based nodes and one or more machine learning (ML) model-based nodes. Each rule-based node generates a node classification of a document by evaluating the information of the document against one or more corresponding rules. Each ML model-based node can generate a node classification and a probability of the document, where the probability indicates a confidence level in the node classification.

In step 504, the document classification system receives an unclassified set of documents. The unclassified set of documents includes documents that have not yet been assigned a specific category or class and are therefore in need of classification. The unclassified documents can vary in terms of content, format, and metadata attributes, representing diverse information that requires categorization for various purposes. An example unclassified document is illustrated and described in more detail with reference to FIG. 2.

The document classification system can employ various data ingestion methods to acquire the unclassified set of documents. For example, the document classification system can retrieve the unclassified set of documents from local storage or external databases, import documents from external sources via Application Programming Interfaces (APIs) or web scraping techniques, receive the unclassified set of documents directly from users through file uploads, or receive the unclassified set of documents from a messaging system (such as a service bus queue or a streaming topic). In some implementations, real-time data ingestion mechanisms can be implemented to continuously gather new unclassified sets of documents as the unclassified sets of documents become available, ensuring that the document classification system remains up to date with the latest information.

In some implementations, data preprocessing can be applied to normalize the incoming unclassified set of documents to ensure consistency and improve the accuracy of the classification results. Data preprocessing can, in some implementations, be different for different ML models in the classification system, which ensures that the ML model's input aligns with the ML model's expected input. Additionally, data preprocessing can be repeated at various stages while traversing the decision tree to ensure that at each decision point or node, the data is adequately prepared for the next evaluation (e.g., by a rule-based node or an ML-based node). Data preprocessing cleans, transforms, and organizes the raw data of the unclassified set of documents to prepare the unclassified set of documents for further analysis and classification. Normalization can include standardizing the format, structure, and content of the unclassified set of documents to ensure consistency across the dataset. For example, the document classification system can normalize text by converting the text data in the documents within the unclassified set of documents into a uniform format by removing special characters, punctuation, and/or irrelevant symbols. Additionally, text can be converted to lowercase to ensure uniformity in letter casing and prevent potential discrepancies during text matching and comparison. Furthermore, data preprocessing can remove stop words, which are commonly occurring words such as “the,” “is,” and “and” that may not contribute significantly to the classification process. By eliminating stop words, the focus is redirected to the more meaningful terms and phrases within the documents, and leads to more accurate classification results. The document classification system can, in some implementations, break down the text into individual tokens or words. Tokenization enables the document classification system to identify and analyze the semantic meaning of words, phrases, and sentences within the documents.

In step 506, the document classification system classifies each document of the unclassified set of documents. To classify the document, the document classification system traverses through the decision tree by evaluating each document of the unclassified set of documents at corresponding decision nodes. The document classification system uses the evaluations to assign a proposed classification to each document of the unclassified set of documents.

The evaluation of each document at each rule-based node is determined by comparing outcomes of logical conditions within the rule-based node. The rule-based node compares the document's attributes or features against predefined logical conditions established within the rule-based node. The logical conditions can take the form of if-then statements or Boolean expressions that specify criteria for classifying the document (e.g., if “Field1” equals “value,” then return “TRUE”). The document's attributes in the form of structured metadata are extracted and evaluated. Each rule-based node within the decision tree can contain specific logical conditions tailored to assess particular aspects of the document. For example, a rule-based node can evaluate whether a document's author matches a certain value, or if the document's publication date falls within a specified range. Once the document's attributes are retrieved and the logical conditions are defined, the system compares the document's attributes against the conditions specified within the rule-based node. The comparison can include applying Boolean logic to determine whether the document satisfies the conditions or not. Depending on whether the condition is met, the document can be evaluated at different subsequent nodes or assigned different node-based classifications from the rule-based node.

The evaluation of each document at each ML model-based node is determined based on the confidence level satisfying corresponding evaluation thresholds at the ML model-based node. Each ML model-based node can include an ML model trained on labeled data to predict the likelihood of the document belonging to different classes or categories. The ML model-based node can compute the confidence level for the output classification given based on a particular document's attributes and features. The resulting confidence level represents the document classification system's confidence in the classification assigned by the ML model-based node. Once the confidence level is calculated, the document classification system compares the confidence level against the corresponding evaluation threshold set for the ML model-based node. Methods and algorithms used within the ML model of the ML model-based node are illustrated and described in more detail with reference to FIG. 8.

If the confidence level falls below the threshold, indicating lower certainty in the classification outcome, the document classification system can cascade the document to a subsequent decision node for further evaluation. The cascading process allows the document classification system to refine the classification decision or explore alternative classification paths based on additional structured or unstructured data. On the other hand, if the confidence level exceeds the threshold, signaling higher confidence in the classification outcome, the document classification system can directly assign the node classification as the proposed classification to the document. A high confidence level can mean that the classification provided by the ML model-based node meets the predefined criteria for confidence and is deemed reliable enough to be considered as the proposed classification for the document. Alternatively, the document classification system can cascade the document down to a different subsequent node for further classification.

In some implementations, rather than using fixed thresholds, the document classification system can dynamically adjust the thresholds based on the characteristics of the document or the performance of the ML model of the ML model-based node. For example, if the ML model exhibits varying levels of accuracy or predictive power for different types of documents or data distributions, the document classification system can dynamically tune the thresholds to align with the ML model's performance characteristics. This ensures that the threshold values are optimized to effectively differentiate between confident and uncertain classification decisions based on the specific behavior of the ML model.

Additionally, ensemble methods that combine predictions from multiple ML models can be used to improve the robustness of classification decisions and mitigate the impact of uncertainty in individual model predictions. Techniques such as bagging (Bootstrap Aggregating) can be used, where multiple ML models are trained independently on random subsets of the training data, and the models' predictions are aggregated through techniques such as averaging or voting to produce the final classification decision. The approach helps to reduce variance and overfitting by incorporating diverse perspectives from multiple models trained on different subsets of data. Additionally, boosting methods can be used, where a sequence of weak ML models is iteratively trained, with each subsequent model focusing on the samples that were misclassified by the previous models. In some implementations, misclassified samples are added to the training dataset of subsequent models regardless of whether the ML model is weak. By combining the predictions of the sequentially trained models through weighted averaging or other aggregation techniques, boosting can improve overall classification performance by emphasizing the correct classification of previously challenging instances.

The evaluation of each document at a particular ML model-based node can use outputs from multiple ML models. The node classification of the particular ML model-based node is assigned using a combined confidence level of the plurality of ML models. For example, multiple base ML models can be trained, and an overall meta-model can be used to learn how to best combine the multiple base ML models' predictions. The base models' predictions serve as features for the meta-model, which learns to weigh the contributions of each base model's prediction based on each base model's performance on a validation set. Techniques such as random forests, which construct an ensemble of decision trees trained on random subsets of features, can use the diversity of decision trees to reduce overfitting and improve generalization performance, which can be useful for high-dimensional and heterogeneous data such as documents with diverse content.

In some implementations, the ML model within the ML model-based node is trained using previous sets of classified documents to determine patterns or features indicative of each category. The ML model learns to identify patterns or features within the document data that are characteristic of each category. For example, in a text classification task, the model can learn to recognize particular keywords, phrases, or syntactic structures that frequently appear in documents belonging to a certain category. Alternatively, in image classification, the model can learn to detect visual patterns or textures that distinguish between different classes of images. To train the ML model within the ML model-based node, a supervised learning approach can be used, where the ML model is provided with labeled training data consisting of documents and the documents' corresponding category labels. The ML model iteratively adjusts the ML model's internal parameters or weights based on the input data and the associated ground truth labels, minimizing a predefined loss function to improve the ML model's predictive performance over successive iterations.

In some implementations, the ML model within the ML model-based node is trained using unsupervised or semi-supervised learning techniques. In unsupervised learning, the ML model identifies patterns or structures within the data without explicit category labels. The ML model can use clustering algorithms such as k-means clustering or hierarchical clustering, where documents with similar features are grouped together into clusters. Once clustered, the clusters can serve as labeled datasets for supervised learning models, where the clusters provide the basis for training models to recognize and classify documents according to the identified patterns. This approach improves the training process by using unsupervised learning to inform and guide supervised learning tasks, In semi-supervised learning, the ML model uses both labeled and unlabeled data to improve the ML model's classification performance.

In some implementations, the system implements Large Language Models (LLMs) or augmented LLMs such as RAG (Retriever-Augmented Generation). Methods and algorithms for training the LLM are illustrated and described in more detail with reference to FIG. 8. The system trains an LLM using large-scale text corpora and neural network architectures such as Transformer-based models like GPT (Generative Pre-trained Transformer) to learn the patterns and semantics of natural language. During training, the LLM learns to predict the next word or token in a sequence based on the preceding context. The process involves optimizing the model's parameters using techniques that minimize the prediction error (e.g., stochastic gradient descent (SGD)). The trained LLM is incorporated into the document classification system as an ML model-based node.

Augmented LLMs such as RAG incorporate a retrieval mechanism alongside the generation component. The training process for augmented LLMs like RAG uses a generative model and a retriever model. The generative model, based on architectures such as GPT, learns to generate text based on the input context and produces candidate responses or classifications for a given unclassified document. On the other hand, the retriever model retrieves relevant information or context from a large knowledge base, such as a document database or the internet. During training, the generative model and retriever model are trained jointly. The generative model learns to generate responses or classifications that are coherent and contextually relevant, while the retriever model learns to retrieve pertinent information that can augment the generative process. The retrieval component can retrieve relevant passages or documents from a knowledge source based on the input document's context. The retrieved passages provide additional context and information to the LLM, augmenting the LLM's understanding and increasing the quality of the generated classifications.

In some implementations, an LLM is fine-tuned to classify records according to a particular taxonomy. This process involves a supervised learning task where a classifier, trained on labeled data associated with the particular taxonomy, is added to the output layer of the LLM. This approach uses the LLM's pre-existing understanding of natural language and adapts the LLM to the specific classification needs in accordance with the particular taxonomy. This approach allows the system to remain adaptable to the nuances of a particular taxonomy.

In some implementations, the ML model-based nodes include Bayesian reasoning, which enables the system to model uncertainty and update beliefs based on observed evidence. The system can define a probabilistic model that captures the relationship between input data (e.g., document features) and output labels (e.g., document categories). The ML model incorporates prior beliefs about the parameters of the model and updates the beliefs based on observed data using Bayes' theorem. Bayesian inference techniques, such as Markov Chain Monte Carlo (MCMC) or variational inference, are used to approximate the posterior distribution over model parameters. During inference, the system uses the posterior distribution to make predictions or classifications for new documents. Instead of producing a single-point estimate, the system generates a distribution over possible classifications, reflecting the uncertainty in the predictions.

Other classification algorithms that can be used in the ML-based nodes include classification algorithms that produce one or more categorical predictions, such as Support Vector Machines (SVM), Random Forest, K-Nearest Neighbors (KNN), various neural network architectures, and/or LLMs. In some implementations, the classification algorithms can include pre-trained models, while in other instances, fine-tuning may be applied to adapt the pre-trained model to the specific classification requirements.

Fuzzy logic or probabilistic reasoning can be applied in the decision tree. Instead of relying on binary thresholds (e.g., a Boolean value of whether the probability of a model-based node is greater than “0.8”), fuzzy logic and probabilistic reasoning allow for more gradual decision-making based on the degree of certainty or confidence in the classification.

Fuzzy logic enables the system to handle uncertainty and imprecision in the classification process. The document classification system can define membership functions that describe the degree of membership of a data point to various categories or classes. The membership functions can capture the uncertainty associated with each classification decision, allowing the document classification system to make gradual transitions between categories based on the level of confidence in the classification. For example, instead of categorizing a document as either “relevant” or “irrelevant,” fuzzy logic allows the document classification system to assign a degree of relevance to each document based on the strength of evidence supporting the document's classification.

Probabilistic reasoning models uncertainty using probability distributions. Rather than relying on deterministic rules or thresholds, probabilistic reasoning allows the system to assign probabilities to different outcomes based on the available evidence. For example, the document classification system calculates the probability distributions for each potential classification outcome (e.g., politics, sports). Based on the available evidence such as the keywords in the article, the author's reputation, and the publication source, the document classification system assigns probabilities to each category. For example, the probability distribution indicates a 70% likelihood for the document to be about politics and a 30% likelihood for the document to be about sports.

In some implementations, a rule-based node and/or an ML model-based node generates multiple node classifications for the document. For example, one or more ML model-based nodes can be a multinomial model that generates a plurality of classifications and corresponding probabilities for each classification. Unlike binary classification models that only predict between two classes, multinomial models can handle scenarios where there are more than two possible outcomes. The multinomial model is trained on a dataset containing labeled examples across multiple categories. During the training phase, the multinomial model learns the statistical relationships between the input features (e.g., unstructured content, structured metadata) and the various classification categories. The multinomial model estimates the probabilities of each category given the input features, resulting in a probability distribution across all possible classifications. The multinomial model can result in multiple classifications and corresponding probabilities for each classification.

In some implementations, the unclassified set of documents includes structured metadata and/or unstructured content for each document. Each rule-based node can generate the node classification of each document by assessing the structured metadata against the corresponding rule. On the other hand, each ML model-based node can generate the node classification and the probability for the node classification of each document using the structured metadata and/or the unstructured content. The document classification system can, in some implementations, dynamically adjust the evaluation threshold of an ML model-based node based on the structured metadata and/or the unstructured content associated with each document to improve the ML model's classification accuracy.

In some implementations, the threshold probability required for classification can vary depending on factors such as the unclassified document's structured metadata, and/or the performance of previous model-based nodes. A classification with highly specialized content can require a higher threshold probability to confidently assign a classification. Additionally, a higher threshold probability can be used for specific business cases. For example, in scenarios involving sensitive information such as security clearance levels, the classification process can require a higher level of confidence before assigning a classification.

Structured metadata associated with the unclassified document can impact the determination of the threshold probability. For example, documents that include structured metadata with a “source” from reputable sources or authored by experts in the field can be assigned a lower threshold probability due to the source's inherent reliability.

The document classification system can identify, via an ML model-based node within the decision nodes, new information from unstructured content within a particular document. The new information can relate to one or more of the logical conditions within the rule-based nodes. The document system can structure the new information in accordance with the corresponding logical conditions of the corresponding rule-based nodes and evaluate the particular document at the corresponding rule-based nodes. Unstructured content can be evaluated for relevance to determine the unstructured content's impact on the classification process. For example, if the unstructured content contains highly informative textual data (e.g., new information) relevant to the classification task, the system can adjust the threshold probability accordingly to ensure more stringent classification criteria.

In some implementations, the performance of previous model-based nodes in the decision tree can influence the threshold probability required for classification. For example, if preceding model-based nodes consistently produce accurate classifications with high confidence levels, the threshold probability for subsequent nodes can be adjusted accordingly. Conversely, if certain model-based nodes exhibit lower performance or uncertainty in their predictions, the threshold probability can be raised to ensure more cautious classification decisions. In some implementations, the threshold probability can dynamically adapt based on real-time feedback from the document classification system. For example, the document classification system can continuously monitor the performance of model-based nodes and adjust the threshold probability dynamically based on observed classification accuracy.

In some implementations, the document classification system can dynamically determine, for an ML model-based node, a specific ML model from multiple ML models based on the confidence levels of each of the plurality of ML models. For example, ML models with higher confidence levels are prioritized over ML models with lower confidence levels. In some implementations, the document classification system considers factors such as the computational resources required for each ML model, the specificity or generalization capabilities of the ML models, and/or the historical performance of each ML model on similar classification tasks. By considering a combination of factors, the document classification system can make more informed decisions regarding the selection of the ML model that best suits the current classification scenario. Additionally, the document classification system can implement dynamic adaptation mechanisms that continuously monitor and adjust the selection of ML models based on real-time feedback and changes in classification requirements.

In some implementations, the evaluation thresholds of the ML model-based nodes are dynamically adjusted based on the number of categories of the document evaluated by the ML model. The document classification system can determine the number of categories evaluated by the ML model for a particular document. The number of categories refers to the distinct classes or labels that the ML model considers when assigning classifications to documents. For example, in a document classification task involving topics such as sports, technology, and politics, each category represents one of the topics. Based on the number of categories evaluated by the ML model, the document classification system dynamically adjusts the evaluation thresholds associated with the ML model-based nodes. When the ML model evaluates a lower number of categories for a document, indicating a narrower scope or simpler classification task, the document classification system can increase the evaluation threshold. Raising the threshold ensures that the document classification system maintains a higher level of confidence in the classifications assigned by the ML model, given the reduced diversity of categories considered. Conversely, if the ML model evaluates a higher number of categories for a document, suggesting a broader scope or more complex classification task, the document classification system can decrease the evaluation threshold. Lowering the threshold allows the system to be more permissive in accepting classifications with slightly lower confidence levels, considering the increased difficulty of accurately classifying documents across multiple diverse categories.

In some implementations, alternative approaches to dynamically adjusting evaluation thresholds can involve considering additional factors beyond the number of evaluated categories. For example, the document classification system can take into account the distribution of confidence scores across different categories, the overall performance of the ML model on similar classification tasks, and/or the specific requirements or constraints of the document classification application. By incorporating various contextual factors, the document classification system can fine-tune the adaptive threshold adjustment to increase classification accuracy and reliability in diverse classification scenarios. Additionally, the document classification system can continuously analyze historical classification data to refine and improve the dynamic adjustment of evaluation thresholds over time.

In some implementations, while traversing through the decision tree, the document classification system iteratively refines the node classification of each document using multiple ML model-based nodes. For example, the node classification of a subsequent ML model-based node can be progressively narrower than the node classification of a previous ML model-based node. For example, if the initial ML model-based node assigns a broad classification to the document (e.g., “Technology”), a subsequent node can further analyze the document's content to provide a more specific classification (e.g., “Artificial Intelligence”).

The document classification system can, in some implementations, redirect the direction of the traversal through the decision tree by evaluating the document in a previously traversed decision node based on evaluation results at a particular decision node. The document classification system can then explore alternative paths through the decision tree and provide a more complete classification.

In step 508, the document classification system uses the proposed classification of each document of the unclassified set of documents to generate a set of classified documents. In some implementations, the document classification system records indicators of corresponding rule-based nodes or corresponding ML model-based nodes associated with the proposed classification of each document. The indicators serve as metadata or annotations that provide insights into the decision-making process behind each document's classification. By recording such indicators, the system retains information about the specific rules, criteria, or features used to classify each document to increase interpretability.

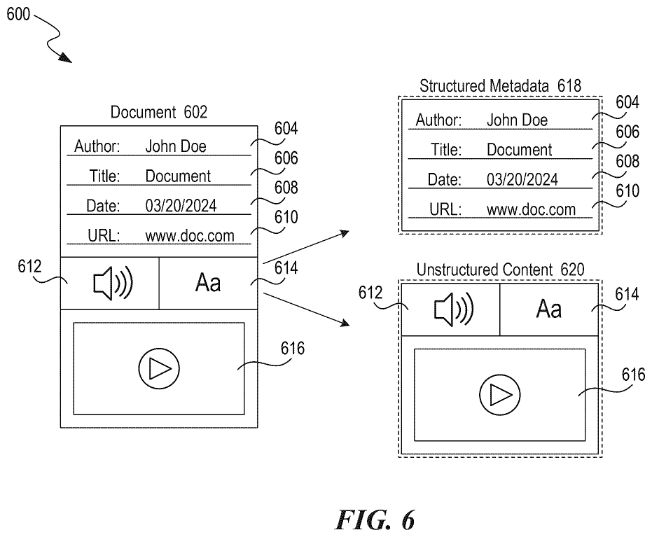

FIG. 6 is a block diagram that illustrates structured metadata and unstructured content within a document 600 that can implement aspects of the present technology.

The document 602 depicted in the diagram encompasses various data elements (e.g., structured, semi-structured, unstructured), which can be used for document classification. The data elements include information such as the author 604, title 606, date 608, and URL 610. For example, the author 604 can represent the individual or entity responsible for creating the document 602, the title 606 can represent the name or heading of the document 602, the date 608 can signify the time when the document 602 was created or last modified, and the URL 610 can serve as a unique identifier or reference point for locating the document 602 within a digital environment.

Additionally, the document 602 can contain one or more multimedia and multi-modal components such as audio segment 612, textual content 614, and/or video component 616. For example, audio segment 612 can contain spoken words or background sounds relevant to the document's 602 context. The textual content 614 can encompass written information in the form of paragraphs, sentences, and/or bullet points. The video component 616 can include visual representations, animations, and/or demonstrations.

The structured metadata 618 within the document 602 is the organized information within the document that is formatted and labeled. The structured metadata 618 is formatted in a predefined manner, making the structured metadata 618 easily identifiable and accessible for classification purposes. Structured metadata 618 can include attributes such as author 604, title 606, date 608, and URL 610. The structured metadata 618 facilitates the classification process by enabling rule-based evaluations and comparisons against predefined criteria.

On the other hand, the unstructured content 620 is the data within the document 602 that lacks a predefined format or organization. Unlike the structured metadata 618, which is organized and labeled, the unstructured content 620 lacks a standardized structure and can vary widely in format and presentation. Unstructured content encompasses elements such as audio segments 612, textual content 614, and video components 616. Unlike the structured metadata 618, which can be analyzed by rule-based nodes, the unstructured content 620 requires more sophisticated processing techniques to extract meaningful information. Since the unstructured content 620 can contain diverse data types and formats, such as natural language text, images, and other multimedia elements, classification algorithms can use techniques such as natural language processing (NLP), image recognition, and audio analysis to interpret and classify the content effectively, which rule-based nodes cannot perform.

In some embodiments, the received document 602 contains semi-structured data. Semi-structured data includes tags or metadata (e.g., structured metadata 618), and may incorporate a hierarchical structure for organization. Additionally, semi-structured data may contain unstructured content (e.g., unstructured content 620). For example, within a structured tabular database table, elements like “description” or “notes” fields may include unstructured text. The structured metadata within semi-structured data can be evaluated in the same manner as structured metadata 618, Similarly, the unstructured data within the semi-structured data can be evaluated in the same manner as unstructured content 620.

While structured metadata 618 provides contextual information that can be readily utilized for rule-based evaluations and comparisons, unstructured content 620 offers further nuanced insights into the document's 620 content and context. For example, textual content 614 within the document 602 can offer detailed information about the document's 602 topic, sentiment, and/or language, while audio segments 612 and video components 616 can provide additional multimedia context.

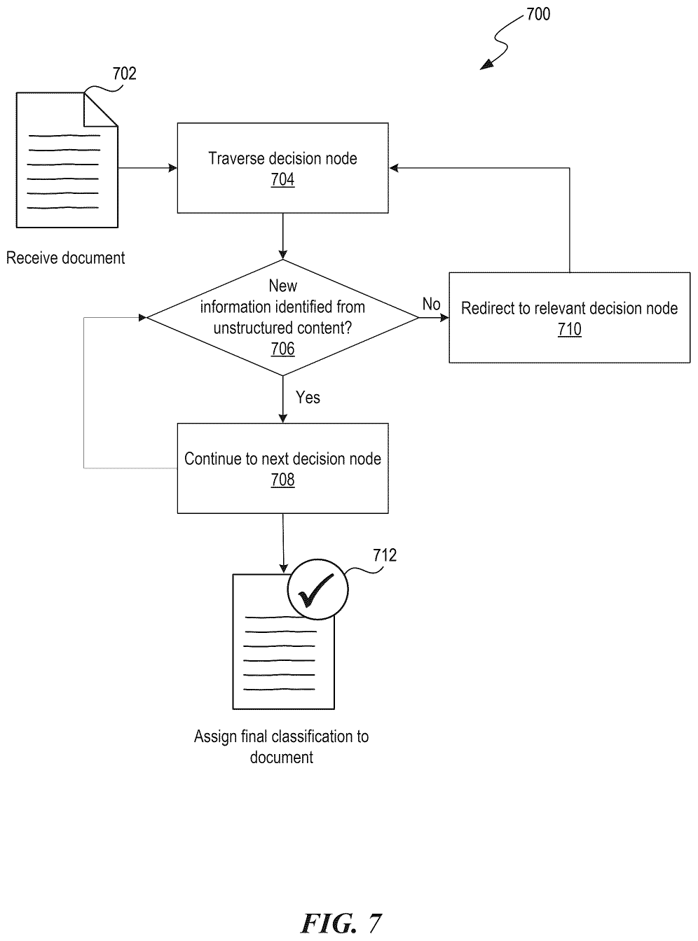

FIG. 7 is a block diagram illustrating a document classification system 700 redirecting the control flow of traversing the decision tree that can implement aspects of the present technology.

The process initiates with the reception of a document 702 and traversing the decision tree starting from the initial ML model-based node 704. Methods and algorithms used within the ML model of the ML model-based node 704 are illustrated and described in more detail with reference to FIG. 5 and FIG. 8. The document classification system parses the document to extract both structured metadata and unstructured content. At decision node 704, the document classification system assesses 706 whether any new information is identified from the unstructured content of the document. New information can include information not already present in the structured metadata, but rather hidden in the unstructured content of the document.

The ML model within the ML model-based node 704 can use natural language processing (NLP) to analyze textual elements. Techniques like tokenization, part-of-speech tagging, and/or named entity recognition enable the system to break down the text into meaningful units and identify important entities like names, locations, or organizations. Additionally, sentiment analysis algorithms can gauge the sentiment expressed in the text, whether it's positive, negative, or neutral, providing deeper context to the content. In some implementations, neural net architectures such as convolutional neural networks (CNNs) can be used for text classification. CNNs can operate on one-dimensional sequences of word embeddings or character embeddings, treating them as spatial sequences. Each convolutional layer in the network applies a set of learnable filters or kernels over the input text, capturing local patterns or features. The filters can parse across the input sequence, performing convolutions to detect relevant patterns at different positions. Max-pooling or average-pooling can extract the most salient features from the convolutional outputs, reducing the dimensionality of the feature maps while retaining important information. The fully connected layers or additional convolutional layers followed by pooling can be used to aggregate features and make predictions regarding the text's classification.

In some implementations, the ML model within the ML model-based node 704 uses lemmatization, stemming, and/or n-gram techniques to prepare the document 702 for use with the MLmodel. Lemmatization reduces words in text to their base or root form, ensuring that different forms of a word are treated as a single item, allowing the system to understand the document's context more accurately. Stemming strips suffixes to reduces words in text to the root form. N-gram techniques break down the text into contiguous sequences of n items (words or characters), capturing the context and sequence of terms, which allows the system to understand the relationships between words in the text.

Computer vision can be used by the ML model within the ML model-based node 704 to analyze visual elements such as images or diagrams present in the document. For example, CNNs allow the document classification system to detect objects, recognize patterns, and extract features from images, identify the objects or scenes depicted, and derive relevant information that contributes to the overall classification process.

Audio elements within the document can also be analyzed by the ML model within the ML model-based node 704 using specialized techniques in NLP and signal processing. Speech recognition algorithms can transcribe spoken words into text, allowing the document classification system to process audio data and extract relevant information. Additionally, audio sentiment analysis algorithms can determine the emotional tone conveyed in the speech, providing further insights into the content.

If new information is detected, the document 602 can progress to the subsequent decision node 708 relevant to the new information and have the system further evaluate the document 702 based on the new information. Conversely, if no new information is identified at decision node 704, the control flow can be redirected to a relevant decision node 710. The redirection ensures an efficient navigation of the decision tree, which optimizes computational resources and minimizes processing overhead.

Once the document 702 reaches a subsequent decision node 708, the system iteratively assesses 706 whether new information is present, enabling continuous refinement of the classification process. The iterative approach allows the system to adaptively incorporate evolving identified information derived from the document's content, improving the accuracy and relevance of the classification outcomes. Upon arriving at a decision node where a proposed classification can be assigned 712, the document 702 is categorized based on the cumulative insights gathered throughout the traversal of the decision tree. The system maps the document 702 to the appropriate category or class based on the collective evaluation of the document's 702 attributes and content.

Overall, the dynamic control flow redirection mechanism depicted in FIG. 7 allows for an adaptive integration of new information from unstructured content into the document classification process, improving the system's adaptability and effectiveness. By iteratively refining classification decisions based on evolving insights, the system becomes more informed during the document categorization.

### AI System

FIG. 8 is a block diagram illustrating an example artificial intelligence (AI) system 800, in accordance with one or more implementations of this disclosure. The AI system 800 is implemented using components of the example computer system 900 illustrated and described in more detail with reference to FIG. 9. For example, the AI system 800 can be implemented using the processor 902 and instructions 908 programmed in the memory 906 illustrated and described in more detail with reference to FIG. 9. Likewise, implementations of the AI system 800 can include different and/or additional components or be connected in different ways.

As shown, the AI system 800 can include a set of layers, which conceptually organize elements within an example network topology for the AI system's architecture to implement a particular AI model 830. Generally, an AI model 830 is a computer-executable program implemented by the AI system 800 that analyzes data to make predictions. Information can pass through each layer of the AI system 800 to generate outputs for the AI model 830. The layers can include a data layer 802, a structure layer 804, a model layer 806, and an application layer 808. The algorithm 816 of the structure layer 804 and the model structure 820 and model parameters 822 of the model layer 806 together form the example AI model 830. The optimizer 826, loss function engine 824, and regularization engine 828 work to refine and optimize the AI model 830, and the data layer 802 provides resources and support for application of the AI model 830 by the application layer 808.

The data layer 802 acts as the foundation of the AI system 800 by preparing data for the AI model 830. As shown, the data layer 802 can include two sub-layers: a hardware platform 810 and one or more software libraries 812. The hardware platform 810 can be designed to perform operations for the AI model 830 and include computing resources for storage, memory, logic, and networking, such as the resources described in relation to FIG. 9. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 810 can include Infrastructure as a Service (IaaS) resources, which are computing resources, (e.g., servers, memory, etc.) offered by a cloud services provider. The hardware platform 810 can also include computer memory for storing data about the AI model 830, application of the AI model 830, and training data for the AI model 830. The computer memory can be a form of random-access memory (RAM), such as dynamic RAM, static RAM, and non-volatile RAM.

The software libraries 812 can be thought of as suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint. Examples of software libraries 812 that can be included in the AI system 800 include Intel Math Kernel Library, Nvidia cuDNN, Eigen, and Open BLAS.

The structure layer 804 can include a machine learning (ML) framework 814 and an algorithm 816. The ML framework 814 can be thought of as an interface, library, or tool that allows users to build and deploy the AI model 830. The ML framework 814 can include an open-source library, an application programming interface (API), a gradient-boosting library, an ensemble method, and/or a deep learning toolkit that work with the layers of the AI system facilitate development of the AI model 830. For example, the ML framework 814 can distribute processes for application or training of the AI model 830 across multiple resources in the hardware platform 810. The ML framework 814 can also include a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830.

Examples of ML frameworks 814 or libraries that can be used in the AI system 800 include TensorFlow, PyTorch, Scikit-Learn, Keras, and Cafffe. Random Forest is a machine learning algorithm that can be used within the ML frameworks 814. LightGBM is a gradient boosting framework/algorithm (an ML technique) that can be used. Other techniques/algorithms that can be used are XGBoost, CatBoost, etc. Amazon Web Services is a cloud service provider that offers various machine learning services and tools (e.g., Sage Maker) that can be used for platform building, training, and deploying ML models.

In some implementations, the ML framework 814 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 800. For example, the ML framework 814 can use a cascade of multiple layers of nonlinear processing units for implicit feature extraction and transformation. Each successive layer uses the output from the previous layer as input. The AI model 830 can thus learn in supervised (e.g., classification) and/or unsupervised (e.g., pattern analysis) modes. The AI model 830 can learn multiple levels of representations that correspond to different levels of abstraction, wherein the different levels form a hierarchy of concepts. In this manner, AI model 830 can be configured to differentiate features of interest from background features.

The algorithm 816 can be an organized set of computer-executable operations used to generate output data from a set of input data and can be described using pseudocode. The algorithm 816 can include complex code that allows the computing resources to learn from new input data and create new/modified outputs based on what was learned. In some implementations, the algorithm 816 can build the AI model 830 through being trained while running computing resources of the hardware platform 810. The training allows the algorithm 816 to make predictions or decisions without being explicitly programmed to do so. Once trained, the algorithm 816 can run at the computing resources as part of the AI model 830 to make predictions or decisions, improve computing resource performance, or perform tasks. The algorithm 816 can be trained using supervised learning, unsupervised learning, semi-supervised learning, and/or reinforcement learning.

Using supervised learning, the algorithm 816 can be trained to learn patterns (e.g., map input data to output data) based on labeled training data. The training data can be labeled by an external user or operator. For example, a user can collect a set of training data, such as by obtaining a set of documents with structured metadata and unstructured content (detailed further in FIG. 6), as well as the documents' corresponding classifications. The user can label the training data based on one or more classes and trains the AI model 830 by inputting the training data to the algorithm 816. The algorithm determines how to label the new data based on the labeled training data. The user can facilitate collection, labeling, and/or input via the ML framework 814. In some instances, the user can convert the training data to a set of feature vectors for input to the algorithm 816. Once trained, the user can test the algorithm 816 on new data to determine if the algorithm 816 is predicting accurate labels for the new data. For example, the user can use cross-validation methods to test the accuracy of the algorithm 816 and retrain the algorithm 816 on new training data if the results of the cross-validation are below an accuracy threshold.

Supervised learning can involve classification and/or regression. Classification techniques involve teaching the algorithm 816 to identify a category of new observations based on training data and are used when input data for the algorithm 816 is discrete. Said differently, when learning through classification techniques, the algorithm 816 receives training data labeled with categories (e.g., classes) and determines how features observed in the training data (e.g., features of data of FIGS. 2-7 such as attributes within the structured metadata or newly identified information within the unstructured content) relate to the categories (e.g., classifications). Once trained, the algorithm 816 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 816 is continuous. Regression techniques can be used to train the algorithm 816 to predict or forecast relationships between variables. To train the algorithm 816 using regression techniques, a user can select a regression method for estimating the parameters of the model. The user collects and labels training data that is input to the algorithm 816 such that the algorithm 816 is trained to understand the relationship between data features and the dependent variable(s). Once trained, the algorithm 816 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 816 learns patterns from unlabeled training data. In particular, the algorithm 816 is trained to learn hidden patterns and insights of input data, which can be used for data exploration or for generating new data. Here, the algorithm 816 does not have a predefined output, unlike the labels output when the algorithm 816 is trained using supervised learning. Another way unsupervised learning is used to train the algorithm 816 to find an underlying structure of a set of data is to group the data according to similarities and represent that set of data in a compressed format. The document classification system 300, 400, 700 disclosed herein can use unsupervised learning to identify patterns in data detailed in FIG. 6 (e.g., documents with structured metadata, unstructured content, and no classification), and so forth. In some implementations, performance of the document classification system 300, 400, 700 using unsupervised learning is improved by improving the unclassified document input provided to the computer system of the device, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 816 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 816 can be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that can be used by the algorithm 816 include factor analysis, item response theory, latent profile analysis, and latent class analysis.

In some implementations, the AI system 800 trains the algorithm 816 of AI model 830, based on the training data, to correlate the feature vector to expected outputs in the training data. As part of the training of the AI model 830, the AI system 800 forms a training set of features and training labels by identifying a positive training set of features that have been determined to have a desired property in question, and, in some implementations, forms a negative training set of features that lack the property in question. The AI system 800 applies ML framework 814 to train the AI model 830, that when applied to the feature vector, outputs indications of whether the feature vector has an associated desired property or properties, such as a probability that the feature vector has a particular Boolean property, or an estimated value of a scalar property. The AI system 800 can further apply dimensionality reduction (e.g., via linear discriminant analysis (LDA), PCA, or the like) to reduce the amount of data in the feature vector to a smaller, more representative set of data.

The model layer 806 implements the AI model 830 using data from the data layer and the algorithm 816 and ML framework 814 from the structure layer 804, thus enabling decision-making capabilities of the AI system 800. The model layer 806 includes a model structure 820, model parameters 822, a loss function engine 824, an optimizer 826, and a regularization engine 828.

The model structure 820 describes the architecture of the AI model 830 of the AI system 800. The model structure 820 defines the complexity of the pattern/relationship that the AI model 830 expresses. Examples of structures that can be used as the model structure 820 include decision trees, support vector machines, regression analyses, Bayesian networks, Gaussian processes, genetic algorithms, and artificial neural networks (or, simply, neural networks). The model structure 820 can include a number of structure layers, a number of nodes (or neurons) at each structure layer, and activation functions of each node. Each node's activation function defines how to node converts data received to data output. The structure layers can include an input layer of nodes that receive input data, an output layer of nodes that produce output data. The model structure 820 can include one or more hidden layers of nodes between the input and output layers. The model structure 820 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 822 represent the relationships learned during training and can be used to make predictions and decisions based on input data. The model parameters 822 can weight and bias the nodes and connections of the model structure 820. For example, when the model structure 820 is a neural network, the model parameters 822 can weight and bias the nodes in each layer of the neural networks, such that the weights determine the strength of the nodes and the biases determine the thresholds for the activation functions of each node. The model parameters 822, in conjunction with the activation functions of the nodes, determine how input data is transformed into desired outputs. The model parameters 822 can be determined and/or altered during training of the algorithm 816.

The loss function engine 824 can determine a loss function, which is a metric used to evaluate the AI model's 830 performance during training. For example, the loss function engine 824 can measure the difference between a predicted output of the AI model 830 and the actual output of the AI model 830 and is used to guide optimization of the AI model 830 during training to minimize the loss function. The loss function can be presented via the ML framework 814, such that a user can determine whether to retrain or otherwise alter the algorithm 816 if the loss function is over a threshold. In some instances, the algorithm 816 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 826 adjusts the model parameters 822 to minimize the loss function during training of the algorithm 816. In other words, the optimizer 826 uses the loss function generated by the loss function engine 824 as a guide to determine what model parameters lead to the most accurate AI model 830. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 826 used can be determined based on the type of model structure 820 and the size of data and the computing resources available in the data layer 802.

The regularization engine 828 executes regularization operations. Regularization is a technique that prevents over- and under-fitting of the AI model 830. Overfitting occurs when the algorithm 816 is overly complex and too adapted to the training data, which can result in poor performance of the AI model 830. Underfitting occurs when the algorithm 816 is unable to recognize even basic patterns from the training data such that it cannot perform well on training data or on validation data. The regularization engine 828 can apply one or more regularization techniques to fit the algorithm 816 to the training data properly, which helps constraint the resulting AI model 830 and improves its ability for generalized application. Examples of regularization techniques include lasso (L1) regularization, ridge (L2) regularization, and elastic (L1 and L2 regularization).

In some implementations, the AI system 800 can include a feature extraction module implemented using components of the example computer system 900 illustrated and described in more detail with reference to FIG. 9. In some implementations, the feature extraction module extracts a feature vector from input data. The feature vector includes n features (e.g., feature a, feature b, . . . , feature n). The feature extraction module reduces the redundancy in the input data, e.g., repetitive data values, to transform the input data into the reduced set of features such as feature vector. The feature vector contains the relevant information from the input data, such that events or data value thresholds of interest can be identified by the AI model 830 by using the reduced representation. In some example implementations, the following dimensionality reduction techniques are used by the feature extraction module: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

### Computer System

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in the specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite the change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer-implemented method for automated document classification, the method comprising:
maintaining a decision tree comprising a set of decision nodes, the set of decision nodes including one or more rule-based nodes and one or more machine learning (ML) model-based nodes,
wherein each rule-based node is configured to generate a node classification of a document by assessing information of the document against one or more corresponding rules, and
wherein each ML model-based node is configured to generate the node classification and a probability of the document indicating a confidence level in the node classification;
receiving an unclassified set of documents;
classifying each document of the unclassified set of documents by:
traversing through the decision tree by evaluating each document of the unclassified set of documents at corresponding decision nodes,
wherein the evaluation of each document at each rule-based node is determined by comparing outcomes of logical conditions within the rule-based node,
wherein the evaluation of each document at each ML model-based node is determined based on the confidence level satisfying corresponding evaluation thresholds at the ML model-based node, and
wherein a respective node classification and a respective probability of the document generated b a particular ML model-based mode within the one or more ML model-based nodes operate as an input for a subsequent rule-based node or ML model-based node within the decision tree, and
using the evaluations, assigning a proposed classification to each document of the unclassified set of documents; and
using the proposed classification of each document of the unclassified set of documents, generating a set of classified documents.

2. The computer-implemented method of claim 1, wherein
traversing through the decision tree further comprises:
iteratively refining the node classification of each document using a plurality of ML model-based nodes,
wherein the node classification of a subsequent ML model-based node is progressively narrower than the node classification of a previous ML model-based node.

3. The computer-implemented method of claim 1, wherein the unclassified set of documents includes one or more of: structured metadata or unstructured content for each document, further comprising:
identifying, via a ML model-based node within the set of decision nodes, new information from the unstructured content within a particular document,
wherein the new information is related to one or more of the logical conditions within the one or more rule-based nodes;
structuring the new information in accordance with the corresponding logical conditions of the corresponding rule-based nodes; and
evaluating the particular document at the corresponding rule-based nodes.

4. The computer-implemented method of claim 1, further comprising:
in response to the confidence level at a particular ML model-based node of a particular document being less than the corresponding evaluation threshold, cascading the document to a first subsequent decision node within the set of decision nodes; and
in response to the confidence level at a particular ML model-based node of a particular document being greater than the corresponding evaluation threshold, cascading the document to a second subsequent decision node within the set of decision nodes,
wherein the first subsequent decision node is different from the second subsequent decision node.

5. The computer-implemented method of claim 1, further comprising:
in response to the confidence level at a particular ML model-based node of a particular document being greater than the corresponding evaluation threshold, assigning the node classification as the proposed classification to the document.

6. The computer-implemented method of claim 1,
wherein the unclassified set of documents includes one or more of: structured metadata or unstructured content for each document,
wherein each rule-based node is configured to generate the node classification of each document using the structured metadata against the corresponding rule, and
wherein each ML model-based node is configured to generate the node classification and the probability for the node classification of each document using one or more of: the structured metadata or the unstructured content.

7. The computer-implemented method of claim 1, further comprising:
recording indicators of one or more of: corresponding rule-based nodes or corresponding ML model-based nodes associated with the traversal through the decision tree of each document.

8. A system for dynamically managing network selection of wireless devices comprising:
at least one hardware processor; and
at least one non-transitory memory storing instructions, which, when executed by the at least one hardware processor, cause the system to:
maintain a decision tree comprising a set of decision nodes, the set of decision nodes including one or more rule-based nodes and one or more machine learning (ML) model-based nodes,
wherein each rule-based node is configured to generate a node classification of a document using one or more corresponding rules, and
wherein each ML model-based node is configured to generate the node classification and a probability of the document indicating a confidence level in the node classification;
receive an unclassified set of documents;
classify each document of the unclassified set of documents by:
traversing through the decision tree by evaluating each document of the unclassified set of documents at corresponding decision nodes,
wherein a respective node classification and a respective probability of the document generated by a particular ML model-based node within the one or more ML model-based nodes are configured to operate as an input for a subsequent rule-based node or ML model-based node within the decision tree, and
using the evaluations, assigning a proposed classification to each document of the unclassified set of documents; and
using the proposed classification of each document of the unclassified set of documents, generate a set of classified documents.

9. The system of claim 8, wherein traversing through the decision tree further comprises:
iteratively refine the node classification of each document using a plurality of ML model-based nodes,
wherein the node classification of a subsequent ML model-based node is progressively narrower than the node classification of a previous ML model-based node.

10. The system of claim 8, wherein the instructions further cause the system to:
dynamically determine, for at least one ML model-based node, a specific ML model from a plurality of ML models for a corresponding decision node within the decision tree based on confidence levels of each of the plurality of ML models,
wherein ML models with higher confidence levels are prioritized over ML models with lower confidence levels.

11. The system of claim 8,
wherein the unclassified set of documents includes one or more of: structured metadata or unstructured content for each document,
wherein the evaluation of each document at each ML model-based node is determined based on the confidence level satisfying corresponding evaluation thresholds at the ML model-based node,
further comprising:
dynamically adjust the evaluation threshold of at least one ML model-based node based on one or more of: the structured metadata or the unstructured content associated with each document, wherein the adjustment improves classification accuracy of the proposed classification for the document.

12. The system of claim 8, wherein at least one ML model-based node is trained using previous sets of classified documents to determine patterns or features indicative of each category.

13. The system of claim 8,
wherein at least one ML model-based node is configured to receive multi-modal inputs,
wherein the multi-modal inputs include one or more of: text, image, audio, or video data.

14. The system of claim 8, wherein at least one decision node in the set of decision nodes generates a plurality of node classifications for the document.

15. A non-transitory, computer-readable storage medium comprising instructions recorded thereon, wherein the instructions when executed by at least one data processor of a system, cause the system to:
maintain a decision tree comprising a set of decision nodes, the set of decision nodes including one or more rule-based nodes and one or more machine learning (ML) model-based nodes,
wherein each rule-based node is configured to generate a node classification of a document using one or more corresponding rules, and
wherein each ML model-based node is configured to generate the node classification and a probability of the document indicating a confidence level in the node classification;
obtain an unclassified set of documents;
classify each document of the unclassified set of documents by:
traversing through the decision tree by evaluating each document of the unclassified set of documents at corresponding decision nodes,
wherein a respective node classification and a respective probability of the document generated by a particular ML model-based node within the one or more ML model-based nodes are configured to operate as an input for a subsequent rule-based node or ML model-based node within the decision tree, and
using the evaluations, assigning a proposed classification to each document of the unclassified set of documents.

16. The non-transitory, computer-readable storage medium of claim 15, wherein the instructions further cause the system to:
iteratively refining the node classification of each document using a plurality of ML model-based nodes,
wherein the node classification of a subsequent ML model-based node is progressively narrower than the node classification of a previous ML model-based node.

17. The non-transitory, computer-readable storage medium of claim 15, wherein at least one ML model-based node includes a multinomial model that generates a plurality of classifications and corresponding probabilities for each classification for a corresponding document.

18. The non-transitory, computer-readable storage medium of claim 15, wherein the instructions further cause the system to:
redirecting a direction of the traversal through the decision tree by evaluating the document in a previously traversed decision node.

19. The non-transitory, computer-readable storage medium of claim 15,
wherein the evaluation of each document at a particular ML model-based node uses outputs of a plurality of ML models,
wherein the node classification of the particular ML model-based node is assigned using a combined confidence level of the plurality of ML models, the combined confidence level determined by:
assigning a weight to each of the plurality of ML models,
calculating the combined confidence level in accordance with the weights and corresponding outputs of the plurality of ML models.

20. The non-transitory, computer-readable storage medium of claim 15,
wherein the evaluation of each document at each ML model-based node is determined based on the confidence level satisfying corresponding evaluation thresholds at the ML model-based node,
wherein the evaluation threshold of a particular ML model-based node is dynamically adjusted based on a number of categories of the document evaluated by the particular ML model-based node,
wherein the evaluation threshold is increased in response to a lower number of evaluated categories, and
wherein the evaluation threshold is decreased in response to a higher number of evaluated categories.
